(19) United States
(12) Patent Application Publication
(10) Pub. No.: US 2015/0150654 A1
(43) Pub. Date: Jun. 4, 2015

(54) HYBRID SURFACE-TREATED IMPLANT FIXTURE

(71) Applicant: DIO CORPORATION, Busan (KR)

(72) Inventor: Youngmin Park, Busan (KR)

(21) Appl. No.: 14/406,235

(22) PCT Filed: Jun. 10, 2013
(86) PCT No.: PCT/KR2013/005077

§ 371 Date: Dec. 8, 2014

(30) Foreign Application Priority Data
Jun. 12, 2012 (KR) 10-2012-0062881

(51) Int. Cl. A61C 8/00

(52) U.S. Cl. CPC A61C 8/0037; A61C 2008/0046

(57) ABSTRACT

An implant fixture of the present invention comprises an upper and lower dual hybrid outer surface treated by: blasting alumina, titanium oxide, calcium oxide and the like at a high pressure at an outer lower portion of the fixture so as to have a surface roughness of 1.5-3.0 μm; dipping the entire outer surface of the fixture of which the lower portion was blasted, into an etchant comprising hydrochloric acid, sulfuric acid, and water so as to have a surface roughness of 0.2-1.0 μm, thereby allowing a surface upper section (Ua) to have a surface roughness of 0.2-1.0 μm from the upper end of the fixture to a downward position of 2.5 mm; and allowing a lower section (La) below the upper section (Ua) of the fixture to have a surface roughness of 1.5-3.0 μm by blasting and a surface roughness of 0.2-1.0 μm by etching.

### TECHNICAL FIELD

The present invention relates to an implant fixture, and more particularly, to a hybrid surface-treated implant fixture capable of preventing peri-implantitis and implementing excellent osseointegration by differentiating surface roughness of upper and lower sections of a fixture upon surface treatment of the implant fixture.

### BACKGROUND ART

In general, osseointegration with the alveolar bone N important for an implant fixture implanted into the alveolar bone. Stabilization formed by a fitting section between an existing bone and a fixture upon implantation of the fixture serving as a buried body of an implant is referred to as initial stabilization or primary stabilization. Such primary stabilization is affected by a state of a bone material, accuracy of drilling upon implant surgery, a shape of the implant fixture, and so on, and performed for about four weeks after implantation. in addition, stabilization according to generation of an interface between the fixture and the existing bone as time elapses after implantation of the fixture is referred to as secondary stabilization. In general, osseointegration of the implant represents existence and level of such secondary stabilization. Accordingly, the surface treatment of the implant may be a major factor of exerting an influence on the secondary stabilization of the osseointegration.

As the surface treatment method of the implant fixture of the related art, a well-known resorbable blasted media (RBM) surface treatment method of roughly forming a surface of a fixture by a medium such as alumina (Al₂O₃), titanium oxide (TiO₂), calcium oxide (Ca₃PO₄), and so on, through blasting, a method of coating hydroxyapatite or titanium oxide and hydroxyapatite on a surface of a fixture like in the following Patent Literatures 1 and 2, forming a titanium oxide film on a surface, forming a plurality of micro- and nano-sized pores in an upper portion, and then coating hydroxyapatite or ceramic glass on the surface like in Patent Literature 3, a sand-blasted, large-grit, acid-etched (SLA) surface treatment method including a process of roughly forming a surface of an implant fixture through blasting and a process of etching the surface using acid such as hydrochloric acid, sulfuric acid, or the like, as disclosed in Patent Literatures 4 and 5, and a surface treatment method of adding a blasting process to the SLA surface treatment method are widely used.

In the surface treatment methods of the implant fixture, while the entire outer surface of the fixture is treated, when a surface roughness of the fixture is increased, osseointegration can be more rapidly performed than when a new bone is generated from the existing bone when the fixture is implanted into the alveolar bone. However, when the surface roughness is relatively high, since bacteria can easily proliferate on the surface of the fixture and peri-implantitis frequently occurs due to infection by the bacteria after time elapses from implantation of the fixture into the fixture, the implant surgery may be failed due to loss or regression of the alveolar bone due to the peri-implantitis, and thus, the implant surgery should be performed again to cause an increase in overall costs, and so on.

### CITATION LIST

### Patent Literature

### KR 10-2004-0099964 A Dec. 2, 2004

### KR 10-0809574 B1 Feb. 26, 2008

### KR 10-0856031 B1 Aug. 27 , 2008

### KR 10-2003-0078480 A Oct. 8, 2003

### KR 10-2011-0054551 A May 25, 2011

### SUMMARY OF INVENTION

### Technical Problem

In order to solve the problems, an object of the present invention is to provide a hybrid surface-treated implant fixture capable of treating a surface of the fixture upon manufacture of the implant fixture through an SLA surface treatment of the related art such as blasting and etching, and having different surface roughness of upper and lower sections of the fixture. Here, the upper surface roughness of the fixture is lower and denser than that of the lower surface roughness such that the osseointegration with the alveolar bone is more rapidly and smoothly performed at a lower section of the fixture upon implantation of the fixture into the alveolar bone and insertion and proliferation of the bacteria at the upper section of the fixture can be suppressed to effectively prevent the peri-implantitis, maximizing a success rate of the implant surgery.

### Solution to Problem

In order to achieve the aforementioned objects, the present invention is directed to provide a hybrid surface-treated implant fixture. The implant fixture is configured such that an upper section has a lover surface from an upper section downward to 2.5 mm to provide surface roughness of 1.5 to 3.0 μm through blasting of injecting alumina, titanium oxide, calcium oxide, or the like, at a high pressure. In addition, the fixture is configured such that the entire outer surface of the fixture is submerged in an etching solution, in which hydrochloric acid, sulfuric acid, and water are mixed, after blasting the lower section of the fixture, to provide surface roughness of 0.2 to 1.0 μm. The upper 2.5 mm area of the fixture has surface roughness of 0.2 to 1.0 μm formed through etching, and a lower section of the upper 2.5 mm area of the fixture has surface roughness of 1.5 to 3.0 μm formed through blasting and surface roughness of 0.2 to 1.0 μm formed through etching.

### Advantageous Effects of Invention

According to the specific means to solve the above-mentioned problem, the surface of the implant fixture, generally formed of titanium, has at least two roughnesses through blasting and etching. The upper section is configured to have low roughness of 0.2 to 1.0 μm through etching only, and the lower section is configured to have high roughness of 1.5 to 3.0 μm through blasting and low roughness of 0.2 to 1.0 μm through etching in a dual hybrid type of the upper and lower sections. In the related art, when the entire outer surface of the implant fixture is surface-treated through blasting, mixed treatment of blasting and etching, coating with hydroxyapatite, or the like, in order to improve osseointegration performance, the surface roughness is increased to be vulnerable to insertion and proliferation of bacteria or the like. However, according to the hybrid surface-treated implant fixture of the present invention, the lower surface roughness of the fixture is increased to maximize osseointegration performance, which is most important in implantation of the fixture, and the upper surface roughness is decreased to suppress insertion and proliferation of bacteria after implantation of the fixture, thereby preventing peri-implantitis, increasing a success rate of long-term implant, and inducing rapid bone incorporation.

### BRIEF DESCRIPTION OF DRAWINGS

FIG. 1 is a view showing an exemplary example of a hybrid surface-treated implant fixture of the present invention; and

FIG. 2 is a block diagram showing an example of a manufacturing method of the present invention.

### DESCRIPTION OF EMBODIMENTS

Hereinafter, an embodiment of the present invention will be described with reference to the accompanying drawings.

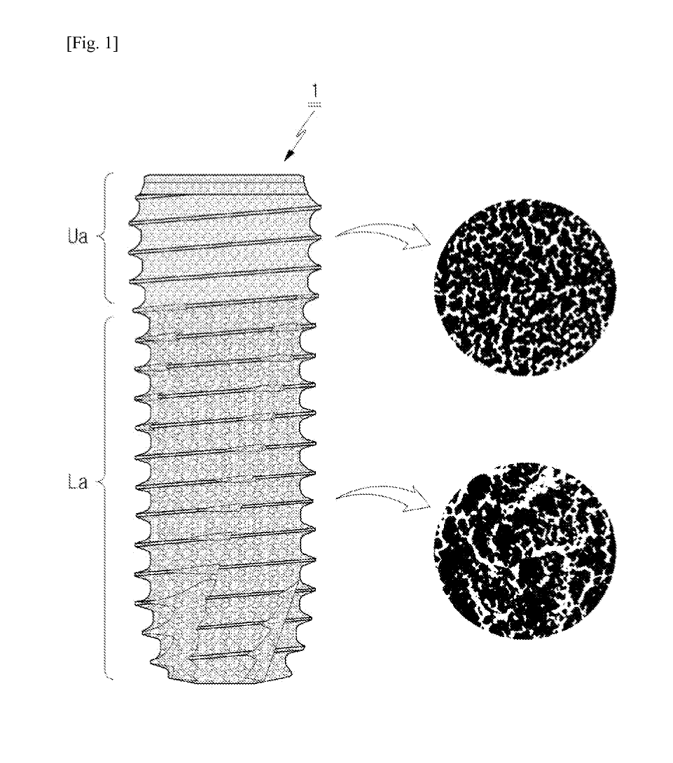

In the present invention, as shown in FIG. 1, an outer surface of an implant fixture 1 implanted into the alveolar bone is divided into an upper area La formed downward to about 2.5 mm from an upper end thereof and a lower area La from a lower side of the upper area Ua to a lower end thereof to have different surface roughness of the upper area Ua and the lower area La, thereby improving a success rate of an implant surgery.

While the upper area Ua outside the implant fixture 1 is an area formed downward to about 2.5 mm from the upper end of the fixture 1 as described above, the upper area may be an area from the upper end of the fixture 1 to a center thereof according to the entire length of the fixture 1. In addition, while the lower area La outside the fixture 1 is an area formed from the lower side of the upper area Ua, formed downward to about 2.5 mm from the upper end, to a lower end of the fixture 1, the lower area may be an area from the center to the lower end when the upper area Ua is formed from the upper end to the center of the fixture 1.

The upper area Ua of the implant fixture 1 of the present invention has a plurality of pores having a surface roughness of 0.2 to 1.0 μm through surface treatment such as etching, and the lower area La of the fixture 1 has a plurality of pores having a surface roughness of 1.5 to 3.0 μm and a plurality of pores having a surface roughness of 0.2 to 1.0 μm through surface treatment such as blasting and etching, respectively.

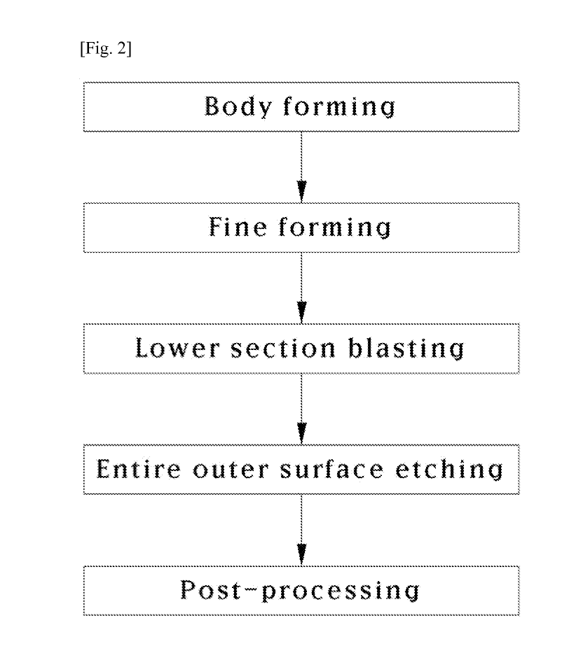

As a method of forming the upper area Ua and the lower area La of the fixture 1 having different surface roughness, as shown in FIG. 2, a conventional fixture 1 is manufactured through a body forming step of compressing and heat-treating a source powder to form a shape of the fixture 1, and a fine forming step of forming a coupling hole configured to couple various abutments to an upper section of the fixture 1 after the forming step and a screw section configured to implant the fixture 1 into the alveolar bone in a threaded manner through forging. Next, the hybrid surface-treated implant fixture 1 of the present invention as shown in FIG. 1 is manufactured through a blasting step of covering the upper area Ua of the fixture 1 and then forming the surface of the lower area La to have surface roughness of 1.5 to 3.0 μm through blasting of injecting alumina, titanium oxide, calcium oxide, or the like, at a high pressure, and an etching step of removing the cover that covers the upper area Ua of the fixture 1, submerging the fixture 1 into an etching solution in which hydrochloric acid, sulfuric acid, and water are mixed, and appropriately adjusting a reaction temperature and a reaction time to etch the entire outer surface of the fixture 1 to have surface roughness of 0.2 to 1.0 μm.

According to the above-mentioned surface treatment method, as described above, the lower area La of the fixture 1 goes through two manufacturing steps such as blasting and etching to provide a plurality of pores having high surface roughness of 1.5 to 3.0 μm and a plurality of pores having low surface roughness of 0.2. to 1.0 μm, and the upper area Ua of the fixture 1 goes through one manufacturing step such as etching to provide a plurality of pores having surface roughness of 0.2 to 1.0 μm. Accordingly, the fixture 1 of the present invention having the upper area La and the lower area La have different surface roughness and is manufactured through the etching step and then a post-processing step such as cleaning, drying, and packaging.

The implant fixture 1 of the present invention configured and manufactured through dual hybrid surface treatment of upper and lower sections may be variously manufactured in addition to the manufacturing method of FIG. 2 according to necessity. The manufacturing method of FIG. 2 is an example of the various manufacturing methods, and the upper area Ua and the lower area La have different surface roughness through the blasting step and the etching step even when the fixture is manufactured in any method. As described above, the blasting and the etching may also be implemented through various methods. In addition, the manufacturing method can be variously implemented, for example, each of the blasting and the etching may be performed twice without being limited to one time. Various media such as alumina, titanium oxide, calcium oxide, and so on, may be used as a medium injected at a high pressure in the blasting step. In the etching step, a mixing ratio of the hydrochloric acid, sulfuric acid, and water to manufacture the etching solution may be variously applied according to the surface roughness of the fixture 1. Further, at least two of hydrochloric acid, sulfuric acid, and water may be mixed, or another acidic solution may be applied.

The hybrid surface-treated implant fixture 1 of the present invention having the above-mentioned configuration has the upper area Ua and the lower area La of the outer surface having different surface roughness. Here, the upper area Ua has low surface roughness of 0.2 to 1.0 μm, and the lower area La has at least two types of surface roughness, for example, high surface roughness of 1.5 to 3.0 μm and low surface roughness of 0.2 to 1.0 μm.

Accordingly, when the fixture 1 is implanted into the alveolar bone, the osseointegration is rapidly and securely performed in the lower area La, and insertion proliferation of bacteria are suppressed in the upper area Ua due to the low surface roughness. As a result, after the fixture 1 is implanted into the alveolar bone, the peri-implantitis can be prevented to maximize a success rate of the implant surgery, and thus, improvement of tooth health can be facilitated.

On the other hand, in the case of the implant fixture 1 of the related art, the entire surface roughness of the outer side is equal. When the entire surface roughness is low, osseointegration performance is decreased, and when the surface roughness is high, osseointegration is improved upon implantation into the alveolar bone. However, after the fixture 1 is implanted into the alveolar bone, the bacteria or the like are easily inserted and proliferated into the upper section of the fixture 1 exposed above the alveolar bone to considerably decrease a success rate of the implant surgery due to loss and degeneration of the alveolar bone. On the other hand, according to the present invention, while the osseointegration is improved by decreasing the upper surface roughness and increasing the lower surface roughness of the outside of the fixture 1, the bacteria cannot be easily inserted and proliferated into the upper section of the fixture 1 exposed above the alveolar bone.

As described above, although the preferable embodiments of the present invention have been shown and described, it will be appreciated by those skilled in the art that substitutions, modifications, and variations may be made in these embodiments without departing from the principles and spirit of the general inventive concept, the scope of which is defined in the appended claims and their equivalents.

### INDUSTRIAL APPLICABILITY

According to the present invention, as the upper and lower sections of the implant fixture have different surface roughness, the osseointegration performance can be improved and the peri-implantitis can be prevented.

1. A hybrid surface-treated implant fixture (1) having an outer surface thereof divided into an upper area (Ua) and a lower area (La) to cause the upper area (Ua) and the lower area (La) to have different surface roughness,
wherein the upper area (Ua) is surface-treated to have a plurality of pores having low surface roughness of 0.2 to 1.0 μm through etching, and
the lower area (La) is surface-treated to have a plurality of pores having high surface roughness of 1.5 to 10 μm and a plurality of pores having low surface roughness of 0.2 to 1.0 μm through blasting and etching, respectively, to perform dual upper and lower surface treatment.

2. A surface treatment method of a dual upper and lower hybrid surface-treated implant fixture, the method comprising:
a forming step of manufacturing a fixture;
a blasting step of covering an upper area (Ua) of the fixture using a cover and blasting a surface of a lower area (La) to provide first surface roughness; and
an etching step of submerging the entire outer surface of the fixture after removing the cover in an etching solution and etching the fixture such that surface roughness of the upper area (Ua) becomes second surface roughness lower than the first surface roughness.

3. The surface treatment method of the implant fixture according to claim 2, wherein the first surface roughness formed in the blasting step is 1.5 to 3.0 μm.

4. The surface treatment method of the implant fixture according to claim 2, wherein the second surface roughness formed at the upper area (Ua) in the etching step is 0.2 to 1.0 μm.

5. A surface treatment method of a dual upper and lower hybrid surface-treated implant fixture, the method comprising:
a forming step of manufacturing a fixture;
an etching step of submerging the entire outer surface of the fixture in an etching solution to etch the fixture to provide second surface roughness; and
a blasting step of covering an upper area (Ua) of the fixture using a cover and blasting a surface of a lower area (La) to provide first surface roughness higher than the second surface roughness.

6. The surface treatment method of the implant fixture according to claim 5, wherein the first surface roughness formed in the blasting step is 1.5 to 3.0 μm.

7. The surface treatment method of the implant fixture according to claim 5, wherein the second surface roughness formed at the upper area (Ua) in the etching step is 0.2 to 1.0 μm.
